(19) United States
(12) Patent Application Publication
(10) Pub. No.: US 2009/0283541 A1
(43) Pub. Date: Nov. 19, 2009

(54) System and apparatus for dispensing pumpable products

(75) Inventors: Stephen F. Compton, Spartanburg, SC (US); Joseph M. Ramirez, Greer, SC (US); William G. Kuecker, Dixon Springs, TN (US); Daniel L. McKamy, Simpsonville, SC (US)

Correspondence Address: Sealed Air Corporation, P.O. Box 464, Duncan, SC, 29334, US

(73) Assignee: Sealed Air Corporation

(21) Appl. No.: 12/152,324

(22) Filed: May 14, 2008

(51) Int. Cl. B65D 83/00; B65D 33/36; B67D 5/00; B65D 35/56

(52) U.S. Cl. 222/105; 222/1; 222/81; 222/82; 222/207

(57) ABSTRACT

The presently disclosed system comprises a pouch to house a pumpable product, a pouch fitment that can be associated with a pump, and an enclosing carton for containing the pouch and fitment. In some embodiments, the system can further comprise a pump operatively connected to the pouch and carton to dispense the pouch contents. The pouch is advantageously configured within the carton in an U-shaped arrangement, allowing the controlled dispensing of a pumpable product.

### TECHNICAL FIELD

The presently disclosed subject matter relates generally to a system and method for dispensing a pumpable product, comprising an enclosing carton, a pouch, and a pumping device.

### BACKGROUND

Vertical form/fill/seal (VFFS) packaging systems have proven to be useful in packaging a wide variety of food and non-food pumpable products. One example of such a system is the Onpack™ packaging system marketed by Cryovac/Sealed Air Corporation (Saddle Brook, N.J., United States of America). The VFFS process is known to those of ordinary skill in the art, and is described in U.S. Pat. No. 4,589,247 to Tsuruta et al., U.S. Pat. No. 4,656,818 to Shimoyama et al., U.S. Pat. No. 4,768,411 to Su, and U.S. Pat. No. 4,808,010 to Vogan, inter alia, all incorporated herein in their entireties by reference thereto.

In such a process, lay-flat thermoplastic film is first advanced over a forming device to form a tube. Next, a longitudinal (vertical) fin or lap seal is made, and a bottom end seal is formed by transversely sealing across the tube with heated seal bars. A pumpable product is introduced through a central, vertical fill tube to the formed tubular film. The pouch is then completed by sealing the upper end of the tubular segment, and severing the pouch from the tubular film above it. The process can be a two-stage process wherein the creation of a transverse heat seal occurs at one stage of the process, and downstream of the first stage, a separate pair of cooling/clamping means contact the newly-formed transverse heat seal to cool and thus strengthen the seal. In some VFFS processes, an upper transverse seal of a first pouch and the lower transverse seal of a following pouch are made. The pouches are then cut and thereby separated between two portions of the transverse seals without the need for a separate step to clamp, cool, clamp, cool, and cut the seals. A commercial example of an apparatus embodying this more simplified process is the Onpack™ 2050A VFFS packaging machine marketed by Cryovac/Sealed Air Corporation.

U.S. Pat. No. 4,603,793 to Stern, incorporated herein in its entirety by reference thereto, discloses a coupling means mounted on the inside wall of a pouch. The coupling means (or fitment) offers several advantages in packaging products, such as the capability of connecting the fitment to a pumping device. The coupling means further permits the contents of the package to be dispensed in a controllable manner. Packaging systems combining the Onpack™ system with the fitment technology of U.S. Pat. No. 4,603,793 have proven effective in providing a pouch-making system wherein a pouch containing a product includes an internal fitment. The fitment is typically near one end of the pouch to ensure that the contents of the pouch are directed, e.g., by gravity, toward and pumped from and through the fitment by a suitable pump dispensing system. One example of a method and apparatus for installing fitments of the type disclosed by Stern is disclosed in U.S. Pat. No. 5,467,581 to Everette, incorporated herein in its entirety by reference thereto. An alternative system is disclosed in U.S. Patent Publication No. 2006/0111224A1 to Caudle, incorporated herein in its entirety by reference thereto.

In comparison, in many industries, including quick service restaurants and the like, pumpable products are typically dispensed from relatively small stainless steel or plastic product wells. Such wells are typically manually filled by store employees, and are usually in one of two arrangements. In the first arrangement, the well is manually filled with a pumpable product, such as flavored toppings, sauces, liquid condiments of various viscosities (ketchup, mustard, mayonnaise, etc.), and the like. The employee spoons out a more or less appropriate amount of the product as needed. The arrangement can sometimes be accessed directly by the customer.

An alternative arrangement includes a cover, typically made of stainless steel, having a portion control pump fitted therein. After manual filling of a well, a cover carrying or accommodating a pump is dropped onto the top of the well. The pump is conventional in nature for this application, and those skilled in the art will be familiar with the various makes and models of pumps and their operation, such that further details are not provided herein. After filling the product well and installing the cover and pump, the pump can be activated as needed, e.g., manually, to dispense a controlled portion of the product from the well, through the pump, and onto a plate, food product, container, etc.

However, the current systems for dispensing pumpable products suffer from several problems. First, product wells tend to be small in volume, typically about 0.5 gallons, such that they require frequent refilling in high-use environments. Second, refilling is accomplished by pouring the product from rigid or semi-rigid containers, such as cans or jugs. When an employee, particularly an inexperienced one, attempts a refill, the process can be untidy, as product misses the well, overflows past the top of the well, etc.

A third problem associated with conventional systems is the need to periodically clean the well. When very viscous and/or high sugar content products are being used, properly cleaning the well can be labor intensive, time consuming, and difficult. In addition, product freshness becomes an issue when the product is disposed in the well for an extended period of time. Product freshness issues can be aggravated by conditions where the product is dispensed at relatively high temperatures, wherein evaporation through long exposure to high temperatures significantly and adversely affects the quality of the product.

Accordingly, there remains a need in the art for a system for dispensing pumpable products that satisfactorily addresses the above-noted deficiencies in prior art systems. The presently disclosed subject matter addresses these and other needs in the art.

### SUMMARY

In some embodiments, the presently disclosed subject matter is directed to a dispensing system for dispensing a pumpable product comprising an enclosing carton and a pouch containing a pumpable product, wherein the pouch is disposed in a substantially U-shaped arrangement within the carton. The pouch can comprise a first wall and a second wall, a first end and a second end, a first side edge and a second side edge, a first transverse seal and a second transverse seal, and a longitudinal seal disposed between the first side edge and the second side edge, and extending from the first transverse seal to the second transverse seal. The pouch can further comprise a fitment disposed on an outer surface of the first wall of the pouch.

In some embodiments, the presently disclosed subject matter is directed to a method for dispensing a pumpable product. More particularly, the method comprises providing a pouch comprising a first wall and a second wall, a first end and a second end, a first side edge and a second side edge, a first transverse seal and a second transverse seal, and a longitudinal seal disposed between the first side edge and the second side edge, and extending from the first transverse seal to the second transverse seal. A fitment is disposed on the outer surface of the first wall of the pouch, wherein the pouch contains a pumpable product. The pouch is adhered inside a carton such that the pouch forms a substantially U-shaped arrangement within the carton. The fitment of the pouch is then connected to a pump device, and the pump device is activated to dispense the pumpable product from the pouch.

In some embodiments, the presently disclosed subject matter is directed to a method for making a dispensing system. Particularly, the method comprises providing a pouch comprising a first wall and a second wall, a first end and a second end, a first side edge and a second side edge, a first transverse seal and a second transverse seal, and a longitudinal seal disposed between the first side edge and the second side edge, and extending from the first transverse seal to the second transverse seal. A fitment is disposed on the outer surface of the first wall of the pouch, wherein the pouch contains the pumpable product. The pouch is then filled with pumpable product and adhered to the interior of a carton such that the pouch forms a substantially U-shaped arrangement in the carton. The fitment of the pouch is then connected to a pump device and the pump device activated to dispense the pumpable product from the pouch.

### BRIEF DESCRIPTION OF THE DRAWINGS

FIGS. 1a and 1b are perspective views of a system for dispensing a pumpable product.

FIG. 2a is a schematic top plan view of a pouch in its sealed and filled condition, having a substantially centrally located fitment.

FIG. 2b is a schematic bottom view of the pouch of FIG. 2a.

FIG. 3 is a perspective view of the presently disclosed pouch.

FIG. 4a is an isometric view of a conventional unfolded blank used to construct a single piece tray-style box carton.

FIG. 4b is an isometric view of the blank of FIG. 4a folded to form a single piece tray-style box carton.

### DETAILED DESCRIPTION

### I. General Considerations

The problems of the prior art can be solved by a dispensing system that utilizes a pouch configured and adapted for sealing with a fitment that can be substantially centrally (geometrically) located on a surface of the pouch. In some embodiments, the fitment is located on an inside surface, outside surface, or both the inside and outside surfaces of the pouch, as set forth in U.S. Pat. No. 5,467,581 to Everette and U.S. Pat. No. 6,860,407 to Gosselin, incorporated herein in their entireties by reference thereto. Such a pouch can be interfaced with a conventional portion control pump or other suitable pumping system, and positioned in an approximate U-shaped arrangement within a carton. End users can purchase the cartons with the pouch correctly positioned therein for ease of use. The pouch and carton system can be used in a wide variety of applications, including but not limited to, bag-in-box configurations. Tests using pumpable products in the disclosed dispensing system have demonstrated that the pouch essentially completely collapses around the fitment as the pouch is evacuated by activating a portion control pump associated with the dispenser.

The presently disclosed subject matter thus provides an improved dispensing system for packaging pumpable materials, such as liquids and the like.

### II. Definitions

While the following terms are believed to be understood by one of ordinary skill in the art, the following definitions are set forth to facilitate explanation of the presently disclosed subject matter.

Unless defined otherwise, all technical and scientific terms used herein have the same meaning as commonly understood to one of ordinary skill in the art to which the presently disclosed subject matter pertains. Although any methods, devices, and materials similar or equivalent to those described herein can be used in the practice or testing of the presently disclosed subject matter, representative methods, device, and materials are now described.

Following long-standing patent law convention, the terms “a”, “an”, and “the” can refer to “one or more” when used in the subject specification, including the claims. Thus, for example, reference to “a pouch” (e.g., “a dispensing pouch”) includes a plurality of such pouches, and so forth.

Unless otherwise indicated, all numbers expressing quantities of components, conditions, and so forth used in the specification and claims are to be understood as being modified in all instances by the term “about”. Accordingly, unless indicated to the contrary, the numerical parameters set forth in the instant specification and attached claims are approximations that can vary depending upon the desired properties sought to be obtained by the presently disclosed subject matter.

As used herein, the term “about”, when referring to a value or to an amount of mass, weight, time, volume, concentration, or percentage can encompass variations of, in some embodiments ±20%, in some embodiments ±10%, in some embodiments ±5%, in some embodiments ±1%, in some embodiments ±0.5%, and in some embodiments to ±0.1%, from the specified amount, as such variations are appropriate in the disclosed system and methods.

As used herein, the term “abuse layer” refers to an outer film layer and/or an inner film layer, so long as the film layer serves to resist abrasion, puncture, and other potential causes of reduction of package integrity, as well as potential causes of reduction of package appearance quality. The abuse layer can comprise any polymer, so long as the polymer contributes to achieving an integrity goal and/or an appearance goal. In some embodiments, the abuse layer can comprise polyamide, ethylene/propylene copolymer (such as, but not limited to, nylon 6, nylon 6/6, amorphous nylon), and/or combinations thereof. In some embodiments, the abuse layer can comprise polymer having a modulus of at least 10⁷ Pascals at room temperature.

As used herein, the term “barrier” and the phrase “barrier layer”, as applied to films and/or film layers, refers to the ability of a film or film layer to serve as a barrier to gases and/or odors. Examples of polymeric materials with low oxygen transmission rates useful in such a layer can include: ethylene/vinyl alcohol copolymer (EVOH), polyvinylidene dichloride (PVDC), vinylidene chloride copolymer such as vinylidene chloride/methyl acrylate copolymer, vinylidene chloride/vinyl chloride copolymer, polyamide, polyester, polyacrylonitrile (available as Barex™ resin), or blends thereof. Oxygen barrier materials can further comprise high aspect ratio fillers that create a tortuous path for permeation (e.g., nanocomposites). Oxygen barrier properties can be further enhanced by the incorporation of an oxygen scavenger, such as an organic oxygen scavenger (e.g., comprising poly(ethylene/methyl acrylate/cyclohexene methyl acrylate, with or without a transition metal catalyst). In some embodiments, metal foil, metallized substrates (e.g., metallized polyethylene terephthalate (PET), metallized polyamide, or metallized polypropylene), or coatings comprising SiOx or AlOx compounds can be used to provide low oxygen transmission to the disclosed package.

As used herein, the term “bulk layer” refers to any layer of a film that is present for the purpose of increasing the abuse-resistance, toughness, modulus, etc., of a film. Bulk layers can comprise polymers that are inexpensive relative to other polymers in the film that provide some specific purpose unrelated to abuse-resistance, modulus, etc. In some embodiments, bulk layers can comprise polyolefin; in some embodiments, at least one member selected from the group comprising ethylene/alpha-olefin copolymer, ethylene/alpha-olefin copolymer plastomer, low density polyethylene, and linear low density polyethylene.

As used herein, the term “filled” refers to a pouch or container that has been loaded with a pumpable product in a manner consistent with personal or commercial filling operations. Thus, in some embodiments, the disclosed pouch can be fully filled, and in other embodiments the pouch can be partially filled.

As used herein, the term “film” includes, but is not limited to, a laminate, sheet, web, coating, and/or the like, that can be used to package a product. The film can be a rigid, semi-rigid, or flexible product, and can be adhered to a non-polymeric or non-thermoplastic substrate such as paper or metal to form a rigid, semi-rigid, or flexible product or composite. The FS laminates, such as FS 7055, sold by Sealed Air Corporation through the Cryovac Division, are examples of packaging materials suitable for the VFFS process. Such laminates are described in U.S. Pat. No. 4,746,562 to Fant, incorporated herein in its entirety by reference thereto. An alternative laminate that can be used in accordance with the presently disclosed subject matter is SCLAIR™ sealant film, an ethylene/alpha-olefin copolymer marketed by DuPont Canada, and described in U.S. Pat. No. 4,521,437 to Storms, incorporated herein in its entirety by reference thereto. Any of a wide variety of other films and laminates useful for dry or wet fluid packaging are available and can be used with the presently disclosed dispensing system.

As used herein, the phrase “inside layer” refers to the outer layer of a multilayer film packaging a product, which is closest to the product, relative to the other layers of the multilayer film.

As used herein, the term “oriented” refers to a polymer-containing material that has been stretched at an elevated temperature (the orientation temperature), followed by being “set” in the stretched configuration by cooling the material while substantially retaining the stretched dimensions. Upon subsequently heating unrestrained, unannealed, oriented polymer-containing material to its orientation temperature, heat shrinkage is produced almost to the original unstretched, i.e., pre-oriented dimensions. More particularly, the term “oriented”, as used herein, can refer to oriented films, wherein the orientation can be produced in one or more of a variety of manners.

As used herein, the phrase “outside layer” refers to the outer layer of a multilayer film packaging a product, which is furthest from the product relative to the other layers of the multilayer film.

As used herein, the term “oxygen scavenger” refers to a composition, compound, continuous or discontinuous film layer, coating, or the like, that can consume, deplete, and/or react with oxygen from a given environment. In some embodiments, an “oxygen scavenger” can include those scavengers disclosed in U.S. Pat. No. 5,350,622 to Speer et al., and the method of initiating oxygen scavenging disclosed in U.S. Pat. No. 5,211,875 to Speer et al., both incorporated herein in their entireties by reference thereto.

As used herein, the term “polymer” (and specific recited polymers) refers to the product of a polymerization reaction, and is inclusive of homopolymers, copolymers, terpolymers, etc.

As used herein, the term “polymerization” can be inclusive of homopolymerizations, copolymerizations, terpolymerizations, etc., and can include all types of copolymerizations such as random, graft, block, etc. In general, the polymers in the films of the presently disclosed pouches can be prepared in accordance with any suitable polymerization process, including slurry polymerization, gas phase polymerization, high pressure polymerization processes, and the like.

The term “pouch” as used herein includes a pouch, a bag, or like containers, either pre-made or made at the point of bagging.

As used herein, the term “pumpable” refers to the ability of a composition to be transported by gravity or by conventional mechanical or pneumatic pumping means from a storage vessel, such as a pouch.

As used herein, the term “seal” refers to any seal of a first region of a film surface to a second region of a film surface, wherein the seal is formed by heating the regions to at least their respective seal initiation temperatures. The heating can be performed by any one or more of a wide variety of manners, such as using a heated bar, hot air, infrared radiation, radio frequency radiation, etc.

As used herein, the term “substantially centrally located” and the like refers to the location of a fitment (more specifically, the central portion of the fitment as seen looking down on the pouch) with respect to the midpoint of the pouch. In some embodiments, the fitment can be located at or near the exact longitudinal central of the pouch, as this can ensure that the pouch will have symmetry when folded.

As used herein, the phrase “tie layer” refers to any internal film layer having the primary purpose of adhering two layers to one another. In some embodiments, tie layers can comprise a non-polar or slightly polar polymer having a polar group grafted thereon. In some embodiments, tie layers can comprise at least one member selected from the group consisting of: polyolefin and modified polyolefin, e.g., ethylene-vinyl acetate copolymer, modified ethylene-vinyl acetate copolymer, heterogeneous and homogeneous ethylene alpha olefin copolymer, and modified heterogeneous and homogeneous ethylene alpha olefin copolymer; more preferably, tie layers can comprise at least one member selected from the group consisting of anhydride grafted linear low density polyethylene, anhydride grafted low density polyethylene, homogeneous ethylene alpha olefin copolymer, and anhydride grafted ethylene-vinyl acetate copolymer.

Although the majority of the above definitions are substantially as understood by those of skill in the art, one or more of the above definitions can be defined hereinabove in a manner differing from the meaning as ordinarily understood by those of skill in the art, due to the particular description herein of the presently disclosed subject matter.

### III. The Dispensing Pouch

III.A. Generally

The presently disclosed subject matter will now be described more fully hereinafter with reference to the accompanying drawings, in which some but not all embodiments are shown. Indeed, the presently disclosed subject matter can be embodied in many different forms and should not be construed as limited to the embodiments set forth herein. Like numbers refer to like elements throughout.

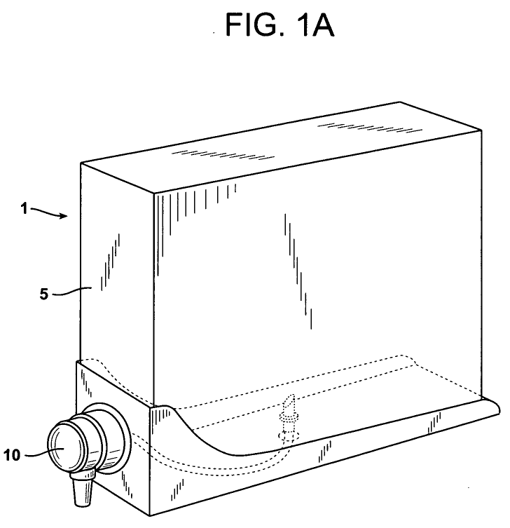

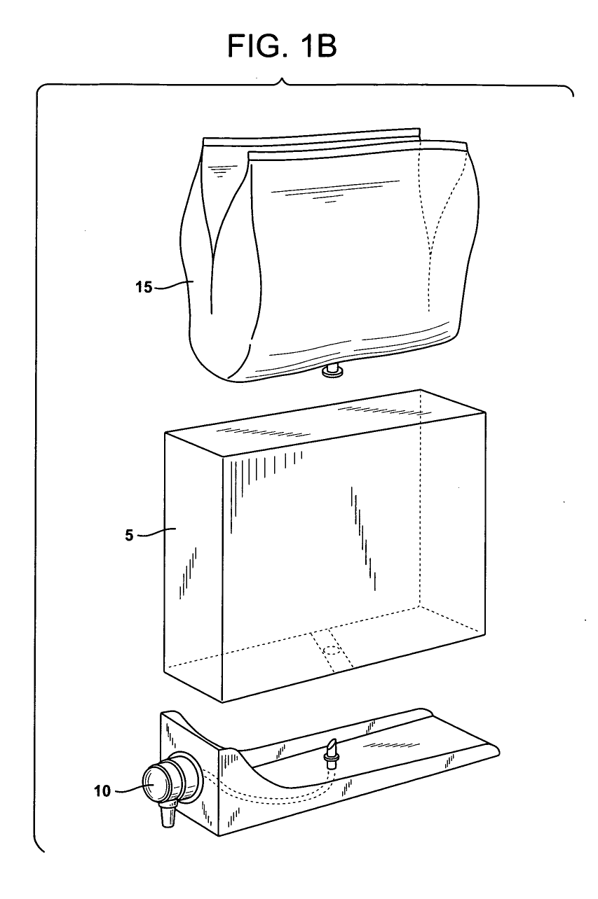

The presently disclosed system comprises a pouch to house a pumpable product, a pouch fitment that can be associated with a pump, and a carton for containing the pouch and fitment. In some embodiments, the system can further comprise a pump operatively connected to the pouch and carton to dispense the pouch contents. FIG. 1a shows in perspective view a dispensing system 1 for dispensing a pumpable product, including carton 5 and pump device 10. Pouch 15 containing a pumpable product and a pouch fitment is enclosed within carton 5, as depicted in FIG. 1b. FIG. 1b illustrates that pouch 15 is folded in a substantially U-shaped configuration and inserted into carton 5. Pouch fitment 30 is associated with pouch 15 such that pump fitment 25 can be aligned with pouch fitment 30 to lock the pump into place. In some embodiments, pouch fitment 30 can be disposed on the outer surface of the first wall of the pouch, approximately halfway between the first and second transverse seals of the pouch.

In some embodiments, valve or pump 10 has a piercing portion to contact, pierce, and/or interlock with pouch fitment 30. Thus, the pump can have a conical or piercing portion matched to the pouch fitment. In some embodiments, the precise construction of the valve or pump for use with pouch 15 can vary so long as it interlocks with pouch fitment 30 to dispense pouch contents. Once the contents of pouch 15 have been dispensed, the end user can detach the pump and dispose of pouch 15 and carton 5, leaving the pump ready for use on the next dispensing system. In some embodiments, the carton and pouch can be assembled and/or purchased pre-equipped with a pump such that when the pouch contents are empty, the pouch, carton, and pump can be discarded.

III.B. Pouch Configuration

As indicated in FIG. 1b, in practice pouch 15 is folded in a substantially U-shaped arrangement, such that both legs of the U are of equal or substantially equal length, and such that pouch fitment 30 is disposed on an outer surface of the pouch, between the two legs of the U and adapted to be connected to a pump. In its folded condition, filled pouch 15 is inserted into carton 5 as shown, and the U-shaped arrangement maintained by means known in the art. For example, pouch 15 can be secured directly to carton 5 by an adhesive applied to the outer surface of the pouch in contact with the carton, to reduce movement of the filled pouch within the carton. The pouch is arranged in the carton such that the side with the fitment is positioned adjacent to a corresponding cut out, slot, or hole in carton 5 to allow contact between the pouch fitment and the pump fitment. The hole and/or slot can be used to securely hold the fitment in position and allow access and easy, automatic, and secure engagement of the fitment with a pump device. Dispensing system 1 can then be shipped to the end user for use.

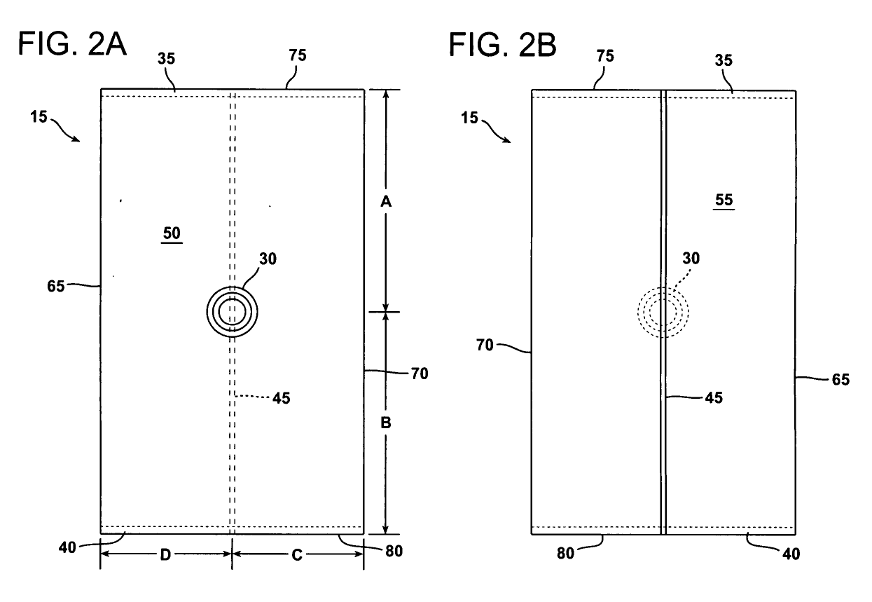

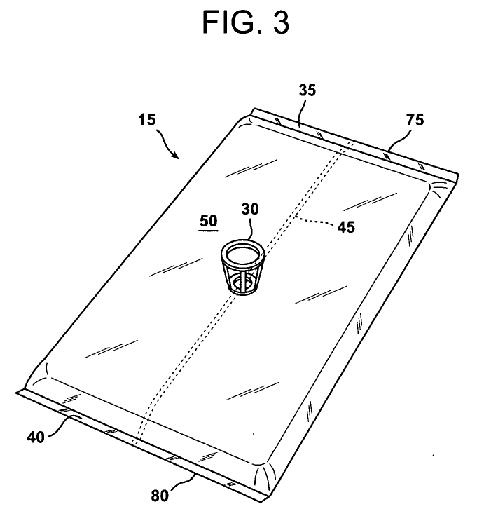

Looking at FIGS. 2a, 2b, and 3, pouch 15 can include first transverse seal 35, second transverse seal 40, and longitudinal seal 45. The various seals can be made by heat sealing, radio frequency, ultrasonic sealing, or any of a wide variety of methods known to those of ordinary skill in the art. The width of the seals can be from about 2 to about 20 millimeters, although other sealing geometries are possible and within the scope of the presently disclosed subject matter. The pouch can include first wall 50 having an outer surface and an inner surface, and second wall 55 having an outer surface and an inner surface. Pouch 15 can also include first side edge 65, second side edge 70, first transverse edge 75, and second transverse edge 80. Pouch fitment 30 can be attached to the outside of first wall 50 and can be substantially centrally disposed between the first and second transverse edges 75, 80 of the pouch. First and second transverse edges 75, 80 are defined by the outer longitudinal extremities of first transverse seal 35 and second transverse seal 40, respectively. In some embodiments, unsealed pouch material can be present between the outer edges of a transverse seal and the actual respective transverse edges of the pouch itself. Such embodiments are also contemplated within the scope of the presently disclosed subject matter.

In some embodiments, it is envisaged that pouch 15 can be produced in various different sizes, depending on the product to be packaged. For example, a 0.5 pint to 5 gallon size (the dimensions of the pouch being adjusted to give the appropriate volume) can be fabricated. Thus, in some embodiments, pouch 15 can be prepared in 0.5, 1, 1.5, 2, 2.5, 3, 3.5, 4, 4.5, 5, 5.5, 6, 6.5, 7, 7.5, or 8 pint (1 gallon) sizes. In addition, 1, 1.5, 2, 2.5, 3, 3.5, 4, 4.5, and 5 gallon pouch sizes can also fall within the scope of the presently disclosed subject matter. Larger or smaller volumes are also contemplated and can be included within the presently disclosed subject matter. In addition, as would be readily apparent to one of ordinary skill in the art, the gallon measurements can easily be converted to liter or other suitable measurements, and vice versa.

Those skilled in the art will understand, after a review of the present application, that the particular shape and size of the pouch can be selected as needed to suit the particular product to be packaged. Likewise, in some embodiments, the pouch size and shape, and location of the fitment on the pouch can be selected to suit existing carton and pump systems.

III.C. Pouch Materials

Pouch 15 can be made from any suitable material, and in some embodiments can be made from a thermoplastic material (including, for example, materials polymeric in composition), with a thickness of between about 0.1 and 100 mils. However, the film used to construct pouch 15 can have any total thickness desired, so long as the film provides the desired properties, e.g., optics, modulus, seal strength, etc., for the particular packaging operation in which the film is used.

In some embodiments film materials suitable for use in pouch 15 can include, but are not limited to, olefin or amide polymers or copolymers. The film can be manufactured by thermoplastic film-forming processes known in the art (e.g., tubular or blown-film extrusion, coextrusion, extrusion coating, flat or cast film extrusion, and the like). A combination of these processes can also be employed.

The film can be oriented or non-oriented. In some embodiments, the film can be oriented in either the machine direction (i.e., longitudinal), the transverse direction, or in both directions (i.e., biaxially oriented) in order to enhance the optics, strength, and durability of the film. If the film is oriented, it can be heat set or annealed after orientation to reduce the heat shrink attribute to a desired level or to help obtain a desired crystalline state of the film.

In some embodiments, the film can comprise one or more polymeric materials in a barrier layer to serve as a barrier to gases and/or odors. Such barrier layers can include, but are not limited to, ethylene/vinyl alcohol copolymer (EVOH), polyvinylidene dichloride (PVDC), vinylidene chloride copolymer such as vinylidene chloride/methyl acrylate copolymer, polyamide, polyester, polyacrylonitrile (available as Barex™ resin), or blends thereof. Oxygen barrier materials can further comprise high aspect ratio fillers that create a tortuous path for permeation (e.g., nanocomposites). The oxygen barrier of materials can be further enhanced by the incorporation of an oxygen scavenger.

In some embodiments, the disclosed film can comprise one or more bulk layers to increase the abuse-resistance, toughness, modulus, etc., of the film. In some embodiments, the bulk layer can comprise polyolefin, including but not limited to, at least one member selected from the group consisting of ethylene/alpha-olefin copolymer, ethylene/alpha-olefin copolymer plastomer, low density polyethylene, and linear low density polyethylene.

In some embodiments, the presently disclosed film can include one or more tie layers. Such tie layers can include, but are not limited to, one or more polymers that contain mer units derived from at least one of C₂-C₁₂ alpha olefin, styrene, amide, ester, and urethane. In some embodiments, the tie layer can comprise one or more of anhydride-grafted ethylene/alpha olefin interpolymer, anhydride-grafted ethylene/ethylenically unsaturated ester interpolymer, and anhydride-grafted ethylene/ethylenically unsaturated acid interpolymer.

In some embodiments, the film can comprise one or more abuse layers that serve to resist abrasion, puncture, and other potential causes of reduction of package integrity, as well as potential causes of reduction of package appearance quality. Particularly, the film should have the required degree of tolerance to pinching and exposure to sharp edges, resulting from contact with the edges of the panels of carton 5. Abuse layers can comprise any polymer, so long as the polymer contributes to achieving an integrity goal and/or an appearance goal. In some embodiments, the abuse layer can comprise at least one member selected from the group consisting of polyamide, ethylene/propylene copolymer; in some embodiments, nylon 6, nylon 6/6, amorphous nylon, and ethylene/propylene copolymer.

The polymer components used to fabricate films according to the presently disclosed subject matter can also comprise appropriate amounts of other additives normally included in such compositions. For example, slip agents (such as talc), antioxidants, fillers, dyes, pigments and dyes, radiation stabilizers, antistatic agents, elastomers, and the like can be added to the disclosed films.

There is generally no limit to the number of layers used for the film structure provided that the various functional requirements are met. Accordingly, the film can comprise 1, 2, 3, 4, 5, 6, 7, 8, 9, 10, 11, 12, 13, 14, 15, 16, 17, 18, 19, or 20 layers.

In some embodiments, the disclosed pouch can be formed from a film, a pumpable product introduced into the pouch, and the open side of the pouch then sealed according to VFFS practices well known to those of ordinary skill in the art. Where the product being packaged is a food product, it can be cooked by subjecting the entire pouch or package to an elevated temperature for a time sufficient to effectuate the degree of cooking desired.

III.D. Pouch Fitment

As represented in FIG. 2a, in some embodiments, pouch fitment 30 can be disposed approximately halfway between first and second transverse edges 75, 80 such that distances “A” and “B” are approximately equal in length. However, in some embodiments, the distances “A” and “B” can be of unequal lengths, such as in J-fold pouches or other pouches well known in the art. The practical limits are those imposed by carton 5. It should be noted that the width of pouch 15 represented by lengths “C” and “D” is such that C can be approximately equal to D. It will be appreciated that lengths A and B and C and D are not always approximately equal in length and can vary according to the specific use desired.

Thus, in some embodiments, pouch fitment 30 can be somewhat off-center laterally, i.e., distance “C” can be less than or greater than distance “D”. In some embodiments, the difference in distance between “C” and “D” can be less than or equal to 50%; in some embodiments, less than or equal to 40%; in some embodiments, less than or equal to 30%; in some embodiments, less than or equal to 20%; and in some embodiments, less than or equal to 10%. Thus, the difference in distance between the fitment and the first transverse seal and the second transverse seal is less than or equal to about 50%, 40%, 30%, 20%, or 10% of the total distance between the seals.

Thus, for example, if “C” is 7.5 centimeters long, “D” can be 7.5 centimeters long as well. However, in some embodiments, “C” can be 9 centimeters long, while “D” is 6 centimeters long, corresponding to a difference in length, between “C” and “D”, of 50%. The practical limits can be those imposed by the pump device used and/or the effectiveness of the pouch fitment in allowing the flow of pumpable material from the two legs of the U-shaped pouch, through the fitment, and out through the pump device. For example, in some embodiments, it is envisioned that pouch fitment 30 can be disposed on or near a side edge. Particularly, in some embodiments, the distance in difference between the fitment and the first side edge and the distance between the fitment and the second side edge is less than or equal to about 50% of the total distance between the first and second side edges.

Although an external fitment (i.e., embodiments wherein the fitment is disposed on the outside surface of the pouch) is depicted in the Figures, a suitable internal fitment can also be used in the disclosed dispensing system. Thus, pouch fitment 30 can be adhered to pouch 15 by any suitable means (such as, for example, adhesives) to the inner and/or outer surface of first wall 50. Pouch fitment 30 can function to cooperate and associate with pump fitment 25. To elaborate, fitments 25, 30 can interlock to stabilize pump 10 and, in some embodiments, can create an airtight and liquid-tight seal to prevent leakage at the fitment site. Thus, pouch 15 can be equipped with a fitment adapted to cooperate with a pump or valve to allow discharge of the pouch contents from pouch 15. In some embodiments, pouch fitment 30 has a portion insertable within pouch 15 to be held therein solely by adhesion to the pouch material.

### IV. The Dispensing Carton

IV.A. Generally

Collapsible plastic bags are often used to store liquid products such as chemicals, soft drink syrups, fruit juices, food condiments, and the like. The plastic bags are typically housed in a corrugated paperboard box to aid in the transporting, handling and dispensing of the product. Such packaging systems are commonly referred to as “bag-in-box” packaging systems. Together, pouch 15 and carton 5 can form a bag-in-box system that is useful for containing and dispensing a pumpable product, such as a liquid. Thus, one aim of the presently disclosed subject matter is to provide a reliable housing system suitable for use with pouch 15 disclosed herein above.

IV.B. Carton Materials

Carton 5 can be suitably formed by folding and sealing a pre-cut blank, which can be manufactured in bulk according to means well known in the art. Suitable substrates from which the blank can be constructed include coated or uncoated paperboard, which can include as a component bleached or unbleached pulp; plastics such as polyolefins, polycarbonates, vinyl polymers, polyesters and acrylics; or any combination thereof. Representative examples of these types of substrates are solid bleached sulfate paperboard (SBS), clay-coated newsback (CCNB), coated solid unbleached sulfate (SUS), multi-ply folding box board or kraft paperboard, or combinations thereof.

In some embodiments, the blank for forming carton 5 can be comprised of multiple layers laminated together to form a substrate. The laminated substrate can be formed by extrusion coating, extrusion lamination, adhesive lamination, dry lamination, solvent coating, aqueous coating, or combinations thereof. For additional barrier properties, oxygen scavengers or other fillers or additives can be incorporated into one or more layers of the laminate.

In some embodiments, the blank can comprise materials suitable for printing, such that any desired graphics or printed materials can be placed upon the carton. Such graphics or printed materials can include, but are not limited to, manufacturer's name, pouch contents, and the like. Such printing methods are known to those of ordinary skill in the art.

IV.C. Carton Configuration

The carton blank can be scored with fold lines to provide a plurality of panels. The plurality of panels can comprise front, rear, top, bottom, and side panels. In some embodiments, the blank can be perforated with a series of cuts to form a tearable opening means. The term “perforated”, as used herein, can refer to the formation of a series of cuts of a predetermined size and configuration through at least part of the thickness of the substrate. The cuts can be made by any suitable means for achieving the desired length, depth, and/or configuration.

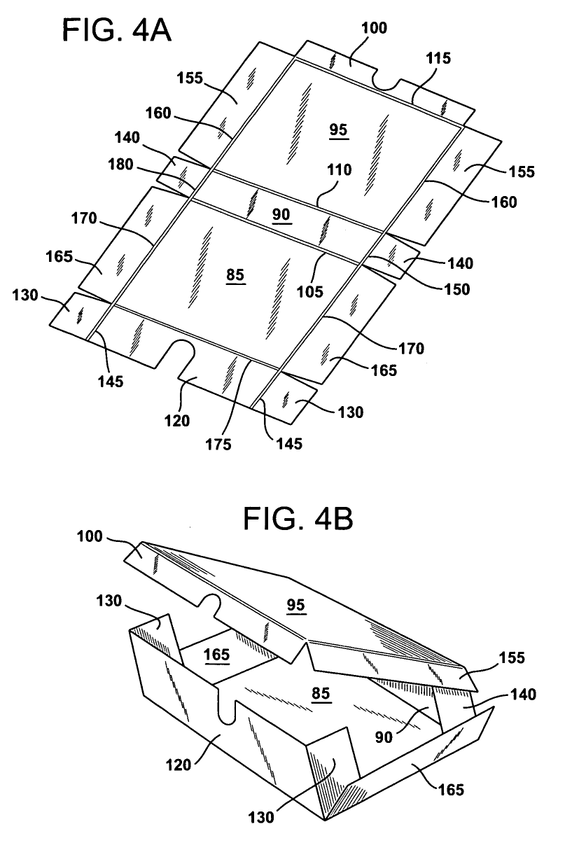

Carton 5 can be constructed by hand or mechanically in any of a variety of ways known to one of ordinary skill in the art. For example, FIG. 4a illustrates an isometric view of a conventional unfolded blank used to construct a single piece tray-style box container. FIG. 4b illustrates an isometric view of the container blank of FIG. 4a folded to form a single piece tray style box container. The conventional tray box style as shown in FIGS. 4a and 4b are single-piece type package systems. However, it will be understood that cartons with parts that are molded separately and then joined by any means known in the art can also be included in the presently disclosed subject matter. Turning first to FIG. 4a, the blank from which the carton is formed is generally rectangular in shape, has an overall planar configuration, and includes top, bottom, and side edges. A plurality of score or fold lines extend in parallel with respect to the sidewalls so that carton 5 can be folded to the configuration in FIG. 4b. One of ordinary skill in the art would readily appreciate that these and a variety of other blanks of various shapes can be used to form a housing in accordance with the presently disclosed subject matter.

In FIG. 4a, panel 85 remains in a stationary position. Panels 90, 95, and 100 are then folded perpendicularly to panel 85 along fold line 105. Panels 100 and 95 are then folded perpendicularly to panel 90 along fold line 110, such that panels 85 and 95 are parallel and facing each other. Panel 100 is then folded perpendicularly to panel 95 along fold line 115, parallel to panel 90. Panel 120 is then folded perpendicularly to panel 85 along fold line 175 to be aligned with panel 100. Panels 120 and 100 are then secured together by means known to those of ordinary skill in the art. Panels 130 and 140 are then folded inside the container along fold lines 145 and 150, respectively. Panels 155 are then folded perpendicular to panel 85 along fold lines 160. Panels 165 are then folded perpendicular to panel 85 along fold lines 170. Panels 155 and 165 are then secured together to form the carton depicted in FIG. 4b. One of ordinary skill in the art would recognize that the above steps can be performed in any order, and are not limited to the order set forth above. After forming the package of FIG. 4b, carton 5 can be oriented in any direction by rotation, i.e., face 85 can be maneuvered to the top of the carton, etc. Thus, in some embodiments, the carton can comprise a bottom panel, a top panel, a first side panel foldably connected to the top panel at a first fold line, a second side panel foldably connected to the top panel, a first plurality of end flaps closing a first end of the carton, and a second plurality of end flaps closing a second end of the carton.

Either before or after pouch 15 is filled, the pouch can be inserted into carton 5. To complete closing of the carton, an end tab and the plain opposite end tab are then folded down on to the top of the pouch in such a manner that the pouch fitment fits neatly into a hole or a plurality of slots formed in the carton. Said hole or slots can be located in a top, bottom, or side panel of carton 5.

In some embodiments, the panels of carton 5 depicted in FIGS. 4a and 4b can be secured by, for example, applying hot-melt resin glue at specific locations (not shown), folding the body at the plurality of fold lines and compressing at the glued panel locations. For example, after filling carton 5 with pouch 15, panel 120 can be lowered into place with the glued front overlapping on the top side of panel 100. Thus, upon folding the side panels upward to the perpendicular position to meet the end panels, the ribbons of hot-melt resin glue on the fold lines come in contact with the exposed edges of the end panels to bring about flute closure or sealing.

Accordingly, the means of sealing the panels can be selected from any appropriate means known in the art, including but not limited to, heat-sealing, ultrasonic welding, applying an adhesive, mechanical locks formed in the blank, or combinations thereof. In the heat-sealing process, a layer of a heat sealable material that has been previously applied to the internal surface of a blank is heated to a temperature at which it is semi-fluid, or tacky. The tacky surfaces are then compressed together such that the heat sealable material on the surfaces fuses to form a seal. In some embodiments, the glue composition can be either a conventional hot melt resin glue, cold set water resistant glue, typically starch or dextrin formulations, or a foaming type hot melt.

In some embodiments, when inserting pouch 15 into carton 5, problems can occur wherein the air remaining in the carton prevents the pouch from being properly inserted and positioned. Such problems can occur as a result of air becoming trapped toward the bottom of carton 5. The problems can be properly addressed by forming one or more air vent holes or slots in carton 5. That is, when inserting pouch 15 into carton 5, the air inside the carton can be released to the outside from the inside bottom through air vents. One of ordinary skill in the art would understand that the holes and/or slots can be located at any desired location on carton 5. In addition, the air vent holes can be any convenient shape, including but not limited to, circular, triangular, quadrangular, or combinations thereof. As another example, slots in panels 100 and 120, which are included to provide external access to pouch fitment 30, can be a hole in some embodiments. Similarly, in some embodiments, it can be desirable to provide cuts or slots in carton 5 to function as a means by which to grip or lift the carton, or to visually inspect the pouch contents or levels of fullness. In some embodiments, the cuts can be made using a laser-cutting means. For example, the substrate can be at least partially penetrated by light pulses from a 100-800 watt carbon dioxide laser. Other suitable methods for creating cuts in carton 5 would be readily apparent to one of ordinary skill in the art.

As mentioned hereinabove, pouch 15 comprises pouch fitment 30 for interlocking with pump fitment 25 located on pump 10. In order for the pouch fitment to be suitably accessed by pump fitment 25, carton 5 can comprise a hole, slot, or similar opening on one or more panels of carton 5 to provide such access. The slots can function to support and keep secure pouch 15 and pouch fitment 30. Thus, in some embodiments, if a user desires to pierce pouch fitment 30 and lock the pouch fitment with the pump fitment, the pouch fitment will remain securely in place. Accordingly, the stability of the position of the pouch fitment can be ensured, even after a degree of rough handling in transportation and storage to allow easy and reliable connection of the pouch fitment to a pump fitment or an extraction nozzle of an apparatus, such as a pump. Thus, at least one panel of carton 5 can be equipped with a hole, plurality of slots, or other opening of sufficient size to allow users to effectively access pouch fitment 30 with pump fitment 25 to provide alignment.

In some embodiments, carton 5 can be folded around pouch 15, or the pouch can be inserted through an opening in the carton, which can then be sealed. In some embodiments, the presently disclosed subject matter comprises a generally cuboid, elongate carton that is folded from a blank containing a filled pouch and a fitment that projects through the bag and through the carton to allow extraction of the contents of the pouch.

Those skilled in the art will understand, after a review of the present application, that the particular shape and size of the carton and pump can be selected as needed to suit the particular size and shape of pouch that is to be made. Alternatively, especially with regard to existing commercial systems that include a product well and conventional pump system, the pouch size and shape, and location of the fitment on the pouch, as well as modifications to the pump system, can be selected to suit the existing carton and pump system.

### V. The Dispensing Pump

A delivery mechanism, such as a pump, can be associated with pouch 15 and carton 5 to selectively deliver the contents of the pouch. Such a pump device suitable for use with the disclosed dispensing system is not limited and can include any of a wide variety of commercially available models.

In some embodiments, pump 10 can include a piercing nozzle for piercing pouch 15 within pouch fitment 30. Thus, a piercing nozzle can be of the general type disclosed U.S. Pat. No. 4,603,793 to Stern, or can of any suitable configuration and geometry known in the art. The pump fitment can fasten and interlock with the pouch fitment to allow the pump to dispense pouch contents without leaks. In some embodiments, the piercing nozzle can be attached to a conventional drawing tube of a conventional pump device. Thus, many alternative embodiments are possible, and can be suitable provided that a fitment disposed on an internal or external surface of the pouch can be brought into communication with a pump device through, for example, a piercing nozzle.

For example, a pump can be fashioned onto carton 5 by means of an interlocking structure between pouch fitment 30 and pump fitment 25. Particularly, pump fitment 25 can comprise a piercing nozzle to pierce and interlock with pouch fitment 30. Pump 10 can also comprise a dispensing means. Such dispensing means are well known in the art, and any of a variety can be used with the presently disclosed subject matter. Thus, the disclosed system allows for easy piercing and connection by inexperienced users. The carton not only holds the fitment in place, but provides a surface to apply pressure against the engagement wherein the outer flange of the fitment presses against the carton.

Thus, a pump suitable for use with the presently disclosed subject matter can encompass various manual or mechanical actuated valves or pumping systems. Examples of very simple manual valves can include, for example, “clothes-pin” style valves. When the viscosity of packaged product is such that the product cannot be dispensed by gravity forces only and/or when an accurate flow control of the product to be dispensed is desired, a pump assembly can be used. For example, a volumetric positive displacement pump assembly, as is well known in the art, can be used with the disclosed dispensing system.

The fitment configuration allows pouch 15 to be hermetically closed prior to piercing the pouch and dispensing. When the pouch is positioned in carton 5 or in lay flat mode, as depicted in FIGS. 2 and 3, pouch fitment 30 can be attached to the pouch with a fitment support means sealed within the pouch and the pouch fitment on the outside of the pouch, i.e., an external fitment. Alternatively, in some embodiments, both the fitment support and the pouch fitment can be sealed within the pouch (i.e., an internal fitment). In such configurations, a closed, safe and non-contaminated environment can be established within the pouch during storage. When dispensing is desired and fluid communication is established, a piercing member (which can be associated with pump 10 in some embodiments) can be pushed within the pouch fitment, causing the pouch film to be cut away and providing an opening for allowing the flow of material to pass from the pouch to a pump. The pouch does not need to be removed from carton 5 to establish fluid communication as the fitment member is accessible through a slot or hole in carton 5. In some embodiments, pump 10 can deliver portion control of the pouch contents upon a push of a corresponding button associated with the pump.

In some embodiments, before the piercing of pouch 15, the contents of the pouch can be maintained in sterile conditions. Sterile conditions can be obtained by known means, such as, for example, by sterilization of the pouch assembly, pouch fitment 30, and subsequent aseptic filling of the pouch with the microbiologically sensitive product. In some embodiments, sterilization can be carried out by irradiation processes, although other means such as heat sterilization can be envisaged.

Beyond the simplest embodiments of the pump device above described, which can be particularly suited for use in simple and economical dispensing systems, many more capabilities are possible. For example, pump 10 can comprise a means of establishing metered flow, means of establishing dose volume, provisions for an electronic output firing signal, use of digital counters, and the like. Such capabilities are well understood to those of ordinary skill in the art.

### VI. Pumpable Products

The presently used dispensing system can be used with a wide variety of pumpable products, including but not limited to, food items and personal care items. Food products suitable for use with the presently disclosed subject matter can include edible products, such as butters, catsup, cheese spreads, chutneys, coffee and other food or beverage extracts, cream, dairy products, dips, essential oils, flavorings, foods, frostings, fruit spreads, glazes, honey, horseradish, jams, jellies, marinades, mayonnaise, mustard, nutritional supplements, oils, preserves, pudding, relish, salad dressings, salsa, sauces (such as hot and pepper sauces, teriyaki sauce, dessert sauces, pesto sauces, pasta sauces, soy sauce, barbeque sauces, sweet and sour sauces, hot, or grilling sauces), seasoning blends, syrups, vinegars, vinaigrettes, or any other types of pumpable food items.

The presently disclosed subject matter can also be used with a wide variety of personal care products, including but not limited to, body oils, body washes, bubble bath, cleaning products (including oils, floor cleaners, carpet cleaners, furniture cleaners, appliance cleaners, disinfectants, gels, glass cleaners, detergents, liniments, pastes, polishes, stain removers, allergen removers, sanitizing systems), colorants, conditioners, creams, deodorants, fabric conditioners, fabric softeners, hairdressings, hair treatments, hand soaps, insect repellants, laundry products, lotions, lubricants, medications, mineral solutions, moisturizers, mouthwashes, ointments, petroleum jellies, pharmaceuticals, salves, shampoos, shaving creams, soaps, sunscreens, and any other types of pumpable personal care items.

Thus, the presently disclosed subject matter can be used for dispensing pumpable products including low viscosity fluids (e.g., juice and non-carbonated beverages), high viscosity fluids (e.g., condiments and sauces), fluid/solid mixtures (e.g., soups), gels, and the like. Non-food products such as fertilizers, motor oil and engine additives, wet cosmetics, medicaments, and the like can also be beneficially packaged and dispensed in the presently disclosed system. One of ordinary skill in the art would appreciate that the above list is not exhaustive, and the presently disclosed system and methods can be used in packaging applications not listed hereinabove.

### VII. Methods of Using the Disclosed System

The presently disclosed system can be carried out using any of a variety of methods. For example, in some embodiments, a first step can include filling of the pouch according to standard VFFS methods well known to those of ordinary skill in the art. A second step comprises providing a pouch comprising a fitment disposed thereon, where the pouch contains the pumpable product. A third step involves placing the pouch in a carton and securing by well known means, such as adhesive. The fitment of the pouch can then be pierced and/or connected to a pump device. The pump can be activated to dispense the pumpable product from the pouch.

In some embodiments, the disclosed system can comprise providing a pouch containing a fitment disposed thereon, wherein the pouch contains a pumpable product. The fitment of the pouch can then be connected to a pump device. The pouch can then be placed and secured in a carton such that the pouch forms a substantially U-shaped arrangement in the carton. The pump is then activated to dispense the pumpable product from the pouch. Thus, in some embodiments, the pouch fitment can be connected to a pump device before the pouch is placed in the carton.

The presently disclosed subject matter also provides methods of storing and dispensing a pumpable product. In some embodiments, a pouch having first and second ends and a fitment is partially formed. The pouch can then be filled with a pumpable product. The formation of the pouch can then be completed by the addition of at least one further seal line. The pumpable product can be stored in the pouch until dispensing of the product is desired. The pouch can be stored separately from the carton in some embodiment, or pre-assembled in the carton. When it is desired to dispense the pumpable product from the pouch, a pump is attached to the pouch by insertion of a portion of the pump into said fitment for retention engagement with the pump. After dispensing the contents, the pouch, pump, and/or carton can be discarded. In some embodiments, the pump and/or carton can be salvaged for later reuse.

The filled pouch in the carton can be delivered to the end user, after prolonged storage if necessary. In some embodiments, the end user can also be provided or sold a valve or pump for use with the particular charge or fitment, or discharge passage, provided on the pouch. The end user can then store the package for later use, whereupon the user can suitably arrange the carton and pierce the female portion of the pouch fitment with a male portion of a pump or valve fitment. Thus, in some embodiments, the valve or pump can have a conical or piercing end fitting matched to the taper of the fitment associated with the pouch. The end user can simply push the piercing fitment of the valve or pump into the fitment in the pouch until it is a tight fit.

Once the contents of a particular pouch have been consumed, the end user can detach the pump and dispose of the pouch and/or carton, leaving the pump ready for use on the next pouch to be opened. Alternatively, in some embodiments, the user can discard the pump with the pouch and carton and purchase a new dispensing system, configured with a pump already attached thereto or packaged therewith.

### VIII. Advantages of the Disclosed Dispenser

The presently disclosed pouches can be used to economically package a wide range of pumpable materials. The pouch provides an easy indicator to the end user (based on their pre-learned methods of removing caps or seals from actual cans, bottles, and/or tubes) as to how the contents of the pouch can be accessed. In some embodiments, graphics on the pouch and/or carton can also help the user to correctly apply the pumpable material onto a desired object by providing a visual indicator as to the precise location of the exit orifice of the pouch. Further, the pouches and cartons can be manufactured economically, thereby allowing producers to offer product to end users with a more significant price reduction compared to those pouches and cartons that have been available in the past.

Currently, flexible pouches are only rarely used for home dispensing of products, such as fabric softeners, cooking oils, etc. These pouches typically have a pump or spout that is time consuming to use and most often is located at the bottom of the package and must be placed at the edge of the counter to dispense the product. The presently disclosed subject matter allows accurate dispensing of the product at a height convenient to the end user. The dispensing opening will not have to be located over the edge of a counter.

In addition, the disclosed dispensing system comprises a carton that can function to hold and store the pouches in an organized manner. The cartons are advantageous in storing the systems in an effective and space-friendly manner. Thus, the disclosed system comprises a carton that can be neatly stacked during storage or while in use. The cartons allow the end user to make the best use of limited storage space by allowing for the stacking of the cartons. In comparison, most liquid or pumpable end user products that are dispensed over time are contained in bottles. The bottles are heavy (adding to freight costs during distribution), not stackable, and have limited label area for graphics.

In addition, the disclosed dispensing system can operate in high hygienic demanding environments, and can achieve substantially complete evacuation of the contents of the pouch and prevent air from being drawn thereinto.

The fitment and pump assembly of the presently disclosed subject matter can advantageously seal the pumpable product in the pouch throughout the shelf life and multiple dispensing of the product. As a result, non-acid products, such as milk-based products, do not require refrigeration during shelf life or usage of the product. However, for certain products it can be desirable to refrigerate the product to provide a better taste, to provide the product at a desired or customary temperature, and/or for any of numerous reasons that are currently known or that later become known. Accordingly, in some embodiments, the presently disclosed system can be used in residential refrigerators and can be easily engaged with dispensing fitments built in by the refrigerator manufacturer, without the need for a pump. For example, it can be possible to gravity-feed juice or other beverages from the pouch or package within the refrigerator to a dispensing area in the door. Thus, the disclosed system provides for extended shelf-life of the contents within the pouch, and allows the pouch to be non-refrigerated during storage and throughout the usage of the pouch (i.e., the pouch can remain non-refrigerated from the first to the last dose dispensed from the pouch).

One advantage of the presently disclosed system is that no manual refilling of the packaged product is necessary. When a pouch is empty, the carton and pouch can be disconnected from the pump, and discarded. A new assembled carton comprising a pouch filled with a pumpable product and fitment can then be installed. The pouch fitment is precisely held in position by the carton such that the dispensing fitment and the pouch fitment are easily and precisely aligned. In some embodiments wherein the pump is pre-installed in the carton, the disclosed system requires no handling of the pouch by the end user to make connections and/or to place in a secondary dispenser. Accordingly, the end user merely aligns and/or pierces the pouch fitment with the pump fitment to dispense the contents of the pouch. Alternatively, the carton can be purchased pre-equipped with a pump such that the end user merely activates the pump to dispense the pouch contents.

The labor intensive cleaning of the product well of prior art dispensing systems is substantially eliminated because the pouch material shields the internal surface of the carton from direct content with the pumpable product. In addition, when the pouch contents are empty a new carton comprising a filled pouch can replace the empty pouch. Further, optimal product freshness is promoted by maintaining the product in an enclosed pouch throughout its useful life.

What is claimed is:

1. A dispensing system for dispensing a pumpable product comprising:
a) an enclosing carton;
b) a pouch disposed in a substantially U-shaped arrangement within the carton, the pouch comprising:
i) a first wall and a second wall, a first end and a second end, a first side edge and a second side edge, a first transverse seal and a second transverse seal, and a longitudinal seal disposed between the first side edge and the second side edge, and extending from the first transverse seal to the second transverse seal; and
ii) a fitment disposed on an outer surface of the first wall of the pouch;
wherein said pouch contains the pumpable product.

2. The dispensing system of claim 1, further comprising a pump device in connected relationship with the fitment of the pouch.

3. The dispensing system of claim 1, wherein the carton comprises a bottom panel; a top panel; a first side panel foldably connected to the top panel; a second side panel foldably connected to the top panel; a first plurality of end flaps closing a first end of the carton; and a second plurality of end flaps closing a second end of the carton.

4. The dispensing system of claim 2, wherein the carton has adapted at least one hole or slot located in at least one panel to securely hold and access the pouch fitment with said pump device.

5. The dispensing system of claim 4, wherein said at least one hole or slot is located on a bottom, top, or side panel of said carton.

6. The dispensing system of claim 1, wherein the pouch fitment is disposed on the outer surface of the first wall of the pouch, about halfway between the first and second transverse seals of the pouch.

7. The dispensing system of claim 1, wherein the pouch fitment is disposed on the outer surface of the first wall of the pouch, such that the difference in the distance between the fitment and the first transverse seal, and the distance between the fitment and the second transverse seal, is less than or equal to about 30% of the total distance between the transverse seals.

8. The dispensing system of claim 1, wherein the pouch fitment is disposed on the outer surface of the first wall of the pouch, such that the difference in the distance between the fitment and the first side edge, and the distance between the fitment and the second side edge, is less than or equal to about 50% of the total distance between the first and second side edges.

9. A method for dispensing a pumpable product comprising:
a) providing a pouch comprising:
i) a first wall and a second wall, a first end and a second end, a first side edge and a second side edge, a first transverse seal and a second transverse seal, and a longitudinal seal disposed between the first side edge and the second side edge, and extending from the first transverse seal to the second transverse seal; and
ii) a fitment disposed on the outer surface of the first wall of the pouch, wherein the pouch contains the pumpable product;
b) adhering the pouch inside a carton such that the pouch forms a substantially U-shaped arrangement in the carton;
c) connecting the fitment of the pouch to a pump device; and
d) activating the pump device to dispense the pumpable product from the pouch.

10. The method of claim 9, wherein the carton comprises a bottom panel; a top panel; a first side panel foldably connected to the top panel; a second side panel foldably connected to the top panel; a first plurality of end flaps closing a first end of the carton; and a second plurality of end flaps closing a second end of the carton.

11. The method of claim 9, wherein the carton has adapted at least one hole or slot located in at least one panel to securely hold the fitment in position and allow access engagement of the fitment with a pump device.

12. The method of claim 11, wherein said at least one hole or slot is located on a bottom, top, or side panel of said carton.

13. The method of claim 9, wherein the pouch fitment is disposed on the outer surface of the first wall of the pouch, halfway between the first and second transverse seals of the pouch.

14. The method of claim 9, wherein the pouch fitment is disposed on the outer surface of the first wall of the pouch, such that the difference in the distance between the fitment and the first transverse seal, and the distance between the fitment and the second transverse seal, is less than or equal to about 30% of the total distance between the transverse seals.

15. The method of claim 9, wherein the pouch fitment is disposed on the outer surface of the first wall of the pouch, such that the difference in the distance between the fitment and the first side edge, and the distance between the fitment and the second side edge, is less than or equal to about 50% of the total distance between the first and second side edges.

16. A method of making a dispensing system, the method comprising
a. providing a pouch comprising:
i) a first wall and a second wall, a first end and a second end, a first side edge and a second side edge, a first transverse seal and a second transverse seal, and a longitudinal seal disposed between the first side edge and the second side edge, and extending from the first transverse seal to the second transverse seal; and
ii) a fitment disposed on the outer surface of the first wall of the pouch, wherein the pouch contains the pumpable product;
b. filling the pouch with a pumpable product;
c. adhering the pouch to the interior of a carton such that the pouch forms a substantially U-shaped arrangement in the carton;
d. connecting the fitment of the pouch to a pump device; and
e. activating the pump device to dispense the pumpable product from the pouch.

17. The method of claim 16, wherein the carton comprises a bottom panel; a top panel; a first side panel foldably connected to the top panel; a second side panel foldably connected to the top panel; a first plurality of end flaps closing a first end of the carton; and a second plurality of end flaps closing a second end of the carton.

18. The method of claim 16, wherein the carton has adapted at least one hole or slot located in at least one panel to secure the fitment in position for engagement with said pump device.

19. The method of claim 18, wherein said at least one hole or slot is located on a bottom, top, or side panel of said carton.

20. The method of claim 16, wherein the pouch fitment is disposed on the outer surface of the first wall of the pouch, halfway between the first and second transverse seals of the pouch.

21. The method of claim 16, wherein the pouch fitment is disposed on the outer surface of the first wall of the pouch, such that the difference in the distance between the fitment and the first transverse seal, and the distance between the fitment and the second transverse seal, is less than or equal to about 30% of the total distance between the transverse seals.

22. The method of claim 16, wherein the pouch fitment is disposed on the outer surface of the first wall of the pouch, such that the difference in the distance between the fitment and the first side edge, and the distance between the fitment and the second side edge, is less than or equal to about 50% of the total distance between the first and second side edges.
